(19) United States
(12) Patent Application Publication
(10) Pub. No.: US 2015/0269651 A1
(43) Pub. Date: Sep. 24, 2015

(54) SYSTEM AND METHOD FOR PURCHASING BY EMBEDDED, PURCHASE-CAPABLE VIDEO PLAYER

(71) Applicants: Thomas Jason Taylor, San Clemente, CA (US); Reyhan Nihat Pasinli, Aliso Viejo, CA (US)

(72) Inventors: Thomas Jason Taylor, San Clemente, CA (US); Reyhan Nihat Pasinli, Aliso Viejo, CA (US)

(21) Appl. No.: 14/599,839

(22) Filed: Jan. 19, 2015

Related U.S. Application Data
(63) Continuation-in-part of application No. 14/464,628, filed on Aug. 20, 2014.
Application No. 14/464,628 is a continuation-in-part of application No. 14/223,678, filed on Mar. 24, 2014.

(51) Int. Cl. G06Q 30/06; G06Q 20/12

(52) U.S. Cl. CPC G06Q 30/0633; G06Q 20/12

(57) ABSTRACT

A method and device for purchase transactions to be consummated within a media player teaches that a media player may offer a virtual shopping cart and the ability to accept financial information such as credit card information in order to complete an entire sale within the confines of an advertisement for a product. In embodiments the player may have a virtual shopping cart module and a financial transaction module and may be offered as a service to sellers by a third party intermediary advertiser which plays the advertisements, handles purchases through the player and then places the order with the seller and confirms the purchase with the buyer.

### FIELD OF THE INVENTION

The present invention relates to internet commerce and video playback. More particularly, the present invention relates to internet commerce which combines these two fields and may be embedded. Most particularly, the present invention relates to the encouragement and facilitation of purchases and the processing of payments made in a media player environment.

### BACKGROUND

The internet can advantageously be used for purchases of all sorts without geographic limitations imposed upon traditional brick and mortar stores. This lead to increased variety of offerings to the individual internet-savvy buyer along with better prices due to increased competition, fewer middlemen, reduced overhead, easy resale and savings of gas and time compared to traditional in-person shopping. Websites likely eBay®, Amazon®, and Craigslist® are leaders in the online sales field and payment processors like PayPal help handle the backend in the present era of internet commerce.

More recently, the connectivity aspect of the internet has emerged as another wonder in the form of media websites. Media websites have proliferated as well, as the internet has allowed users to access content including music, movies, advertisements, games and more. These media files are increasingly unmediated, with content providers of all stripes proliferating: from individuals to large organizations, for profit and non-profit, and so on. Typical media websites include YouTube® and Daily Motion®.

The forms of media can be divided into numerous categories, all of which may be advantageously served by the method and device of the invention. However, one particular type of media is of interest, that is, the combination of audio and video output with associated metadata which is normally simply called “video”. Thus, while the present invention can be used with music, games and so on, the prototypical use is for video.

The process of playing a video file (which as noted previously is usually a combination of video, audio, and metadata) is complicated but well developed. The user's network access device (a tablet, computer, telephone, etc.) will have thereon a software component (program, module, app, etc.) called a browser or something similar. Various common types include Microsoft Internet Explorer®, Mozilla Firefox®, Chrome®, Opera®, and numerous apps used on mobile devices. The browser in turn will download, or come equipped with, another software component (a plug-in in IE, an add-on in Firefox, etc.) which cooperates with the browser when the browser encounters a video file. This is the media player, typical examples include “Media Player” by Microsoft, VLC media player and so on.

This second piece of software is often generically called a “player” (and will be identified by that herein).

In use, the user may be using their browser on their electronic device and may click on a link while viewing a first network location (website), after which the server computer will begin to download the media file associated with the link clicked. A video file, as mentioned, will actually have metadata providing instruction on the handling of the file. The browser will identify the type of media file being downloaded and will activate the appropriate player to play the media. The user sees the player open up and the media content begin playing.

In alternative embodiments, the player may be a proprietary player owned and controlled by a particular organization. The player may in alternative embodiments also be downloaded as part of the media file itself. In yet other embodiments, the HTML5 protocol may be used, thus giving the appearance of no separate player being activated and used.

There are numerous benefits to this arrangement, beyond the general fact that users can now access a vast reservoir of video or other data. In particular relation to the present invention, video files provided online may be advertisements. One example of such advertisements is the “info-tisement” in which the user watches the advertisement in search of information and the information provided includes advertisement of some further product for the user to somehow purchase. One example would be the individual who queries a search engine, “How do I remove a rootkit?” and then is directed to a video file which discusses rootkits and directs the user to a rootkit removal device which can be downloaded. Another type of ad is the stand alone advertisement which the user watches because they wish to see the product advertised. Examples of this would include movie trailers which might be viewed upon media/advertisement websites such as Fandango® or Moviefone®. Another example might be the short movies made to advertise the Assassin's Creed® software, which can be watched as short features even without any interest in the game. Yet another type of advertisement is embedded within games or other media actually during the media play. The stereotypical example of this is product placement in a movie.

Undoubtedly the most common type of video advertisement however is the ad which accompanies an unrelated or only partially related video content. The obvious example of this is the commercial break during a television broadcast. The more modern instantiation of this is the short advertisements seen on media websites such as YouTube®. The user is required (or optionally allowed to skip) an advertisement prior to watching their desired content.

FIG. 3 is a PRIOR ART player, shown playing a fairly typical advertisement. A product is being shown to viewers in a video format, with voice-over description of the product. The player has various controls so a viewer, if interested, might rewind and watch part of the video a second time, turn the volume up and down and so on. However, video directions to outside point of purchase 1002 may be seen. These directions can be telephone numbers along with urging to make a call, a website for further information and so on. In any case, the viewer is required to proactively to elsewhere—an outside purchase location—in order to contemplate a purchase of the product. This disjunction between the moment of producing a demand for a product and the ability to fulfill that demand is a major impediment to the efficacy of advertising. Even in instances in which a link might be provided so that from the player the customer can easily locate the outside purchase location, the customer is still very aware of leaving the advertisement and beginning a new process, thus increasing sales resistance un-necessarily.

A final type of advertisement might be an ad embedded in a social network such as Kakaotalk® or Twitter®. The user would post a link to the video advertisement, for example, as discussed further in co-pending applications, as a result of a purchase of a product.

The advertisement types mentioned nonetheless have some severe disadvantages in common to all types. Most particularly, the very nature of an advertisement is separate from the sale of a product: it is axiomatic that there is no need to advertise to a buyer already in the midst of purchasing a product. However, this fundamental tends to obscure the fact that the contrapositive is NOT true: there is a definite need to promote a sale in the midst of an advertisement.

In the past, advertisers have attempted to bridge the gap from advertisement to actual sale in a variety of ways. One painful method was the hucksterism on shopping networks: “Call now! We've only got 9 units left!”. Certainly, advertisements traditionally had to have a telephone number or address. More recently advertisements may have therein a website address. Even more recently ads may refer to a social network hashtag or similar closed-garden experience.

However, every single one of these methods is in fact merely directing the viewer of the advertisement to another virtual or real-world location: the viewer must access a website, make a telephone call and so on. It is at this stage that the vast majority of viewers of an ad are lost, as they go on to other things, get distracted, or simply cannot access the location to which they are directed. This means that the immediate impact value of the advertisement is greatly diluted, that potential buyers have more time to consider their options, and that impulse buying is virtually eliminated.

Thus the drawback to contemporary video advertising online is that it while it may increase attention, curiosity, and general interest in a product it falls short of actually streamlining subsequent follow-on purchases provoked by the advertisement. To a large extent, individual internet activity particularly that in advertising arenas is controlled by factors such as distractibility and spontaneity.

It would be desirable to provide a simple yet functional system and method for quickly and seamlessly purchasing a product mentioned or promoted in video advertisement online. For example, a system and method that encourages and facilitates instantaneous purchases and even processes payments before the individual purchaser gets distracted or decides not to purchase. It would be desirable to provide such a system and method that are easily understood and used in practice and that do not require a purchaser to leave the video clip in which they initially noticed the product. The present invention meets these and other needs.

### SUMMARY OF THE INVENTION

According to a first aspect the invention provides a system for facilitating online purchases by providing customers and buyers of all types with the means to make a purchase within a media file player. Instead of requiring interested viewers of a media file to go to another website such as an online store, the buyer can make the purchase directly within the advertisement itself, as the player has the capability to provide a virtual shopping cart, run a credit card (or other financial transfer of funds), and place the order.

In a preferred embodiment and best mode now contemplated, the advertiser or provider of the video content and video player may in fact be other than the seller of the product or service. In such a system, the server which provides the player and the file may be separate from the server of the seller. When an order is placed, the intermediary advertiser may charge the credit card, then if the financial transaction goes through may place the order with the seller while sending the confirmation of purchase to the buyer. In such embodiments the system operations (sysop) work of running the server, hardware and software, may be carried out by the third party intermediary.

In alternative embodiments, the seller may directly use the device and system of the invention to sell product, and handle systems operations tasks.

In one embodiment, the invention may be a system of transacting online business. In another embodiment, the invention is a media player which has a virtual shopping cart capability (built in or plug-in), a financial transaction capability (charging a card or bank information or line of credit, etc.), an order fulfillment capability and so on.

All such possible embodiments of “players”, regardless of hardware platform, software platform, client browser, server, nature and location of the player device and whether these are now known or are later developed are understood to fall within the purview of the present application.

Unless otherwise defined, all terms used herein have the same meaning as commonly understood by one of ordinary skill in the art to which this invention belongs. Methods and materials are described herein for use of the present invention; other suitable methods and materials known in the art can also be used. The materials and methods, and examples are illustrative only and not intended to be limiting. All publications, patent applications, patents and other references mentioned herein, are incorporated by reference in their entirety. In case of conflict, the present specification, including definitions will control.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### SUMMARY IN REFERENCE TO CLAIMS

It is thus one aspect advantage, objective and embodiment of the present invention to provide a method of electronic commerce offered by an electronic advertiser/retailer, for use by a customer having an electronic browsing device and financial information, the method comprising the steps of:

providing a player of online media, the player having the ability to play for such customer a first media clip, the player further having a virtual shopping cart module;

displaying the first media clip for such customer, the player being stored in non-volatile memory of a computer processor;

displaying within the first media clip a first product available for a purchase by such customer;

allowing such customer to be aware that the first product is available for the purchase;

providing to such customer during display of the first media clip an option to purchase the first product;

if such customer opts to purchase the first product, saving the first product in the virtual shopping cart;

displaying the virtual shopping cart within the player;

providing within the player an option to complete the purchase;

if such customer opts to complete the purchase, activating a financial transaction module to complete the purchase;

if such completion of the purchase is successful, placing the purchase order with such electronic advertiser/retailer; and

sending a confirmation to such customer of the successful purchase.

It is thus one aspect advantage, objective and embodiment of the present invention to provide a method of electronic commerce, wherein the financial transaction module uses such financial information of such customer in the step of completing the purchase, and wherein such financial transaction information is one member selected from the group consisting of: credit card information, bank routing and account number information, loan information and combinations thereof.

It is thus one aspect advantage, objective and embodiment of the present invention to provide a method of electronic commerce—wherein the step of completing the purchase further comprises:

verifying such financial information by means of one member selected from the group consisting of: verifying a credit card number, security information, and amount, verifying a bank routing number, account number and availability of funds, verifying availability of credit for a loan, and combinations thereof.

It is thus one aspect advantage, objective and embodiment of the present invention to provide a method of electronic commerce—wherein the financial transaction module further:

determines whether such financial information is stored and associated with such customer;

if such financial information is stored and associated then retrieving such financial information for the step of verification;

if such financial information is not stored and associated then prompting such customer to enter such information while still within the player and transaction module.

It is thus one aspect advantage, objective and embodiment of the present invention to provide a method of electronic commerce—further comprising:

if such verification step fails, carrying out one step selected from the group consisting of: prompting such customer to re-enter such financial information, prompting such customer to enter additional financial information, cancelling the purchase, creating a potential fraud alert, and combinations thereof.

It is thus one aspect advantage, objective and embodiment of the present invention to provide a method of electronic commerce, wherein the browsing device is one member selected from the group consisting of: a computer, a mobile device, a telephone, a tablet computing device, and combinations thereof.

It is thus one aspect advantage, objective and embodiment of the present invention to provide a method of electronic commerce, wherein the confirmation comprises one member selected from the group consisting of: an email, a text message, an SMS text message, an audio telephone call, a posting on an internet social media, and combinations thereof.

It is thus one aspect advantage, objective and embodiment of the present invention to provide a method of electronic commerce, wherein the computer processor belongs to such advertiser/retailer and the advertiser/retailer further carries out direct system operations control of the computer processor.

It is thus one aspect advantage, objective and embodiment of the present invention to provide a method of electronic commerce, for use in an environment with an intermediary media advertiser, wherein:

the computer processor belongs to such intermediary media advertiser and such intermediary media advertiser further carries out direct systems operations control of the computer processor.

It is thus one aspect advantage, objective and embodiment of the present invention to provide a method of electronic commerce, further comprising:

offering to such customer the option to skip directly to the completion of the purchase from a point within the display of the first media clip prior to completion of the display of the first media clip.

It is thus one aspect advantage, objective and embodiment of the present invention to provide a a method of electronic commerce, further comprising:

displaying to such customer the virtual shopping cart within the player at a point in time selected from the group consisting of: a specific point within the display of the first media clip, an end of display of the first media clip, after such customer accepts such option to skip directly to the completion of the purchase, and combinations thereof.

It is thus one aspect advantage, objective and embodiment of the present invention to provide a method of electronic commerce, further comprising:

displaying a soft button, wherein clicking on the soft button selects the option to complete the purchase.

It is thus one aspect advantage, objective and embodiment of the present invention to provide a method of electronic commerce, further comprising:

displaying the soft button within the first media clip.

It is thus one aspect advantage, objective and embodiment of the present invention to provide a method of electronic commerce, further comprising:

displaying the soft button within the player.

It is thus one aspect advantage, objective and embodiment of the present invention to provide a method of electronic commerce, further comprising:

displaying within the first media clip an interactive shopping cart icon, capable of causing display of the virtual shopping cart when the icon is activated by such customer.

It is thus one aspect advantage, objective and embodiment of the present invention to provide a method of electronic commerce, further comprising:

displaying within the first media clip an interactive shopping cart status icon, the interactive shopping cart status icon indicating one member selected from the group consisting of: empty status of the virtual shopping cart, number of items in the virtual shopping cart, presence of stored financial information associated with such customer, total cost of items within the virtual shopping cart, and combinations thereof.

It is thus one aspect advantage, objective and embodiment of the present invention to provide a method of electronic commerce, further comprising: displaying a second product after displaying the first product, and displaying all products at a time selected from the group consisting of: when the virtual shopping cart is displayed, at a first end of the media clip, when an all-products icon is activated and combinations thereof.

It is thus one aspect advantage, objective and embodiment of the present invention to provide a method of electronic commerce, wherein the media of the first media clip is one member selected from the group consisting of: metadata, video format data, audio format data, game data, and combinations thereof.

It is thus one aspect advantage, objective and embodiment of the present invention to provide an electronic media player comprising:

a playback module capable of displaying a first media clip;

a purchase module within the player capable of displaying an option to immediately purchase a first product within the first media clip;

a virtual shopping cart module within the player capable of displaying a virtual shopping cart within the first media clip;

a financial transaction module capable of completing a purchase transaction and activated from within the player;

the player being a software module stored upon non-volatile memory in a computer processor.

### BRIEF DESCRIPTION OF THE DRAWINGS

The present application incorporates by reference all matters presented in the following co-pending applications all in the names of the same inventors (T. Jason Taylor and Reyhan Pasinli): U.S. patent application Ser. No. 14/464,628, filed Aug. 20, 2014, and entitled, SYSTEM AND METHOD FOR PURCHASING BY SOCIAL NETWORK STATUS UPDATE OR POST and U.S. patent application Ser. No. 14/464,648, filed Aug. 20, 2014 and entitled, SYSTEM AND METHOD FOR VIRAL PURCHASING, and U.S. patent application Ser. No. 14/223,678 filed Mar. 24, 2014 and entitled, VOICE-KEY ELECTRONIC COMMERCE, including diagrams, specifications and all other parts of these applications.

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram of the components of a system according to an embodiment of the invention.

FIG. 2a is a flow chart illustrating possible steps in a method according to an embodiment of the invention, showing the display and shopping steps prior to a purchase transaction.

FIG. 2b is a flow chart illustrating possible steps in a method according to an embodiment of the invention, showing the display and shopping steps of a purchase transaction.

FIG. 3 is a simplified diagram of a PRIOR ART player which is not capable of purchase transactions.

FIG. 4 is a first diagram of a player according to the invention, showing a first product advertised and showing a virtual shopping cart access icon and status indicator

FIG. 5 is a second diagram of a player according to the invention, showing the first product and showing the “Add to Cart” command enabled to the buyer as a button within the player itself.

FIG. 6 is a third diagram of a player according to the invention, showing that the virtual shopping cart indicator now registers the presence of an item in the cart, while a second item is now being advertised in the video.

FIG. 7 is a fourth diagram of a player according to the invention, showing the second product with the “Add to Cart” button displayed for the user to purchase the second product if desired.

FIG. 8 is a fifth diagram of a player according to the invention, showing yet another product displayed, and showing that the buyer has now placed two items into the virtual shopping cart.

FIG. 9 is a sixth diagram of a player according to the invention, showing the third product is now displayed with the “Add to Cart” button available to the user as shown previously.

FIG. 10 is a seventh diagram of a player according to the invention, showing indicators to the buyer that the video is coming to an end and that it is time to finalize the purchases, along with a cursor (such as might be used on a non-touch enabled device).

FIG. 11 is a view of a player according to the invention as the virtual shopping cart begins to slide into the display area for review by the purchaser.

FIG. 12 is a view of a player according to the invention with the virtual shopping cart displayed, showing the numerous details of a virtual shopping cart.

FIG. 13 is a view of a player according to the invention with the checkout module of the purchase enabled player now displayed for the purchaser to use.

FIG. 14 is a view of a player according to the invention with the order confirmation displayed to the buyer.

FIG. 15 is a view of a player displaying a product but in this case, the player of the invention has been “skinned”, that is, the player looks and may indeed operate differently, but it is still purchase enabled.

FIG. 16 is a view of a player in an alternative embodiment of the invention displaying the virtual shopping cart, showing to the user the option to engage in social shopping, and in addition showing all products from the media clip that was played and highlighting products which might not have been selected by the user.

### INDEX TO REFERENCE NUMERALS

Internet 100
Intermediary media advertiser 102
Seller computer 104
Buyer browsing device, mobile 106
Buyer browsing device, computer 108
PRIOR ART PLAYER 1000
Video directions to outside point of purchase 1002
Purchase capable player 1004
Product 1006
Player controls 1010
Shopping cart access icon 1012
Shopping cart status icon 1014
Shopping cart settings access icon 1016
Product name/identification 1018
Product cost 1020
Add to Cart button 1022
Product advertised in video 1024
Model carrying out actions 1026
Product name/identification 1028
Add to Cart button 1030
Cursor 1036
Indicia 1038
End of video/purchase alert 1040
Virtual shopping cart 1042
Alternative settings icon 1044
Complete purchase button 1046
Virtual shopping cart listing 1048
Close cart button 1050
Item in cart 1052
Item cost 1054
Delete item from cart button 1056
Cost total 1058
Checkout/point of sale module 1060
Status indicator 1062
Name for financial data 1064
Address field one 1066
Address fields 1068
Financial data/cc number 1070
Security code 1072
Expiration date 1074
Back button 1076
Purchase button 1078
Confirmation screen 1080
Controls in different player skin 1090
Load purchase capable player 1102
Load video having metadata Including purchase data 1104
Begin video display 1106
Continue video display 1107
End of video? 1108
Skip to end of video command? 1110
Add to cart command? 1112
Add item to virtual cart 1114
Transfer to checkout process 1116
Financial information on file? 1118
Collect financial information 1120
Verify credit card/information 1122
Send order information to seller 1124
Confirm order to buyer 1126
All products displayed 1200
Social shopping sharing option 1202

### DETAILED DESCRIPTION OF EMBODIMENTS

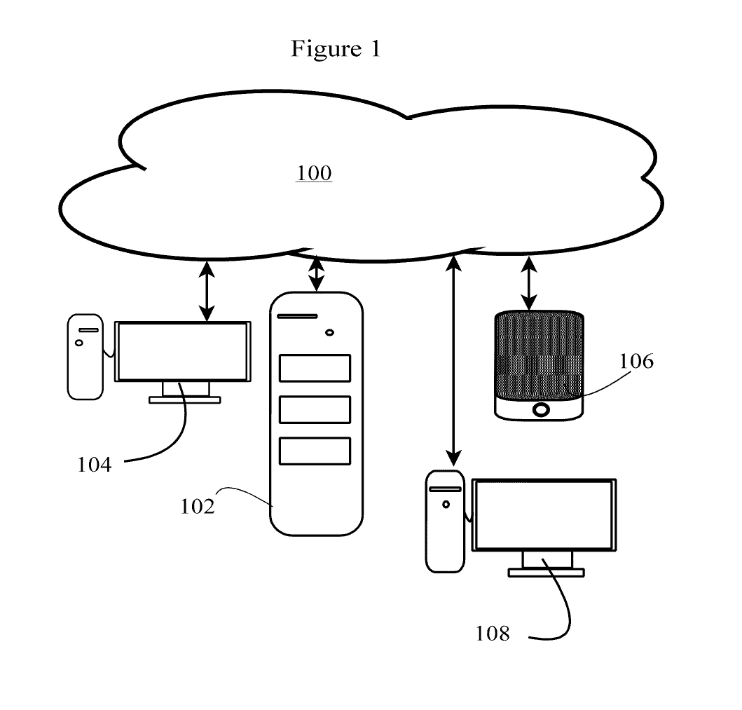

FIG. 1 is a schematic block diagram of the components of a system according to an embodiment of the invention. Internet 100 may be any communication network with advanced display and download functions, such various private garden networks, intranets and so on.

Intermediary media advertiser 102 has server computer which provides the advertising and the purchase enabled player. The player, along with its modules, may be programmed and saved in non-volatile memory on this machine. In practice, the intermediary 102 will handle the advertising, the purchasing within the advertisement, placing the order to the retailer's computer 104 once the credit card charge is verified and sending a confirmation to the buyer's browsing device.

Buyer browsing device 106 may be a mobile device such as a tablet computer, a smart telephone or any other type of device. In general, the only limitation on the device is that it be able to play media clips.

Buyer browsing device 108 may be a conventional computer, of course, again with the sole limitation that it be able to play media clips.

In general, most browsing devices are able to play media clips, using players which are programmed upon the browsing devices. In the present invention, a first step is providing to the customer the player which is purchase capable. This may be provided by a specific download, or by embedding the player into the content, or by licensing this adaptation of the player to established media player providers.

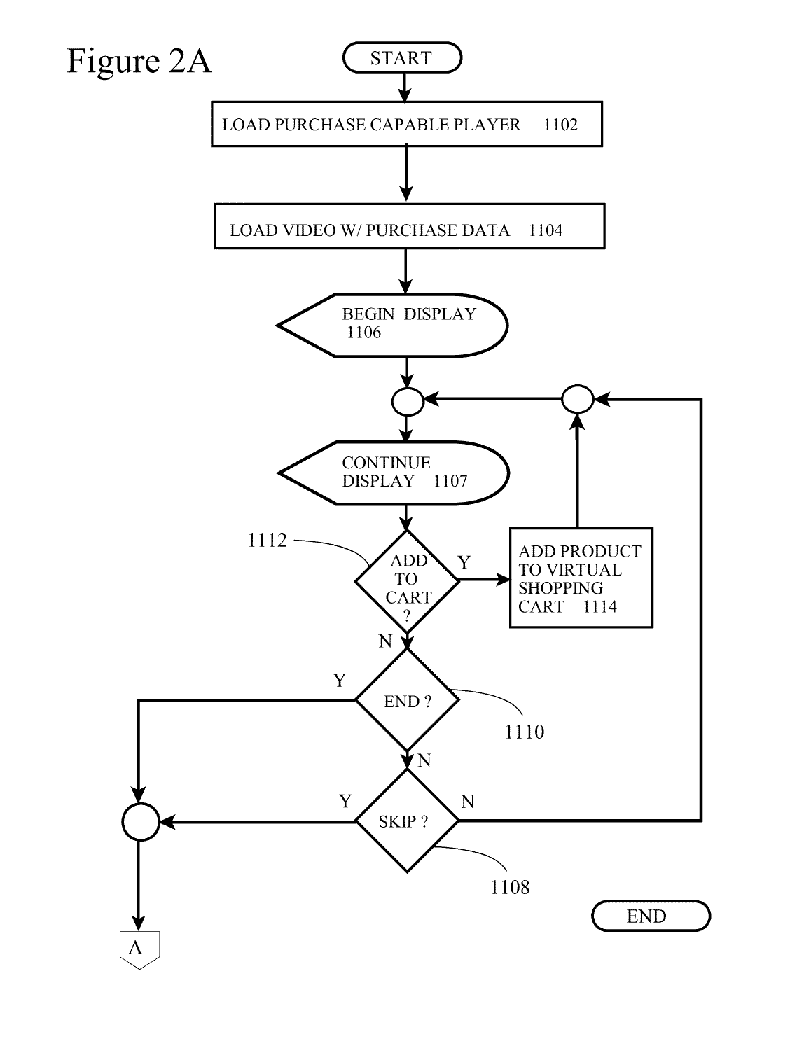

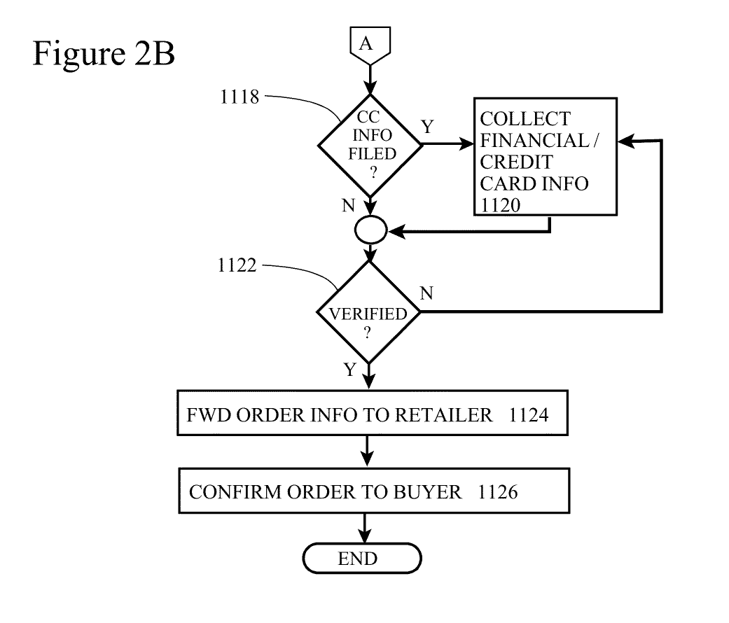

FIG. 2a is a flow chart illustrating possible steps in a method according to an embodiment of the invention, showing the display and shopping steps prior to a purchase transaction.

Load purchase capable player 1102 is the provision of the player, both the step of providing the player to the browsing device and further, the step of activating the player. Load video having metadata including purchase data, step 1104, is the point at which the customer becomes aware that they are playing a particular media clip having the purchase ability built into the clip/player. As noted previously, it is possible that the purchase capability is actually embedded in the content, however, for purposes of this application the term “purchase capable player” includes this arrangement of embedding the proper code into the content.

Beginning video display at step 1106 represents the advertisement, presumably video but possibly in the form a game, audio files, and so on.

Continue video display 1107 represents the continuation of the video playback even if the customer does not order anything, and again after instances of the customer placing items into the virtual shopping cart. In practice, it may be preferable to pause the video for a moment while the system updates the virtual shopping cart within the content/player.

End of video step 1108 monitors the playing/display of the media clip for an end point. When an end point is encountered, the device will then put the customer into the virtual shopping cart, ready for checkout. However, this is not the only way the customer can reach the cart. The customer may activate the active virtual shopping cart icon, which also invokes the virtual shopping cart.

In addition to that, the customer may activate a command or soft button to “Skip to end of video”, shown by the monitoring step 1110. This is for the convenience of extremely enthusiastic customers who may not need to be further “sold” by the advertisement or may be in a hurry to make their purchase, etc. By skipping the rest of the media clip/video, they can be directly deposited into the player shopping cart.

The “Add to Cart” monitor 1112 constantly watches for the customer to activate the soft button or other command which places an item into the virtual shopping cart.

Adding of the product to the virtual cart (1114) occurs immediately after that monitor alerts that the button has been pushed: upon activation, the item is flagged as being in the cart (or in alternative embodiments a data field for the cart is provided with the product ID).

Transfer to checkout process 1116 represents the instantiation of a new module or capability of the system. The financial transaction module is able to accept payment, that is, it is similar to an online POS page. However, prior checkout pages are not known to exist embedded within a media player.

FIG. 2b is a flow chart illustrating possible steps in a method according to an embodiment of the invention, showing the display and shopping steps of a purchase transaction. This is the second half of the process, after the transfer step 1116.

“Financial information on file” step 1118 queries whether the player in fact has the financial information necessary for the transaction already on file. This may occur, for example, if a customer has an account. However, it may also occur in the context of co-pending application in the name of the same applicants, which deal in particular with social network purchasing, voice activated purchasing and related matters. Thus, the system of the present invention may itself be seen to be part of an even larger system which allows multifaceted easier purchasing.

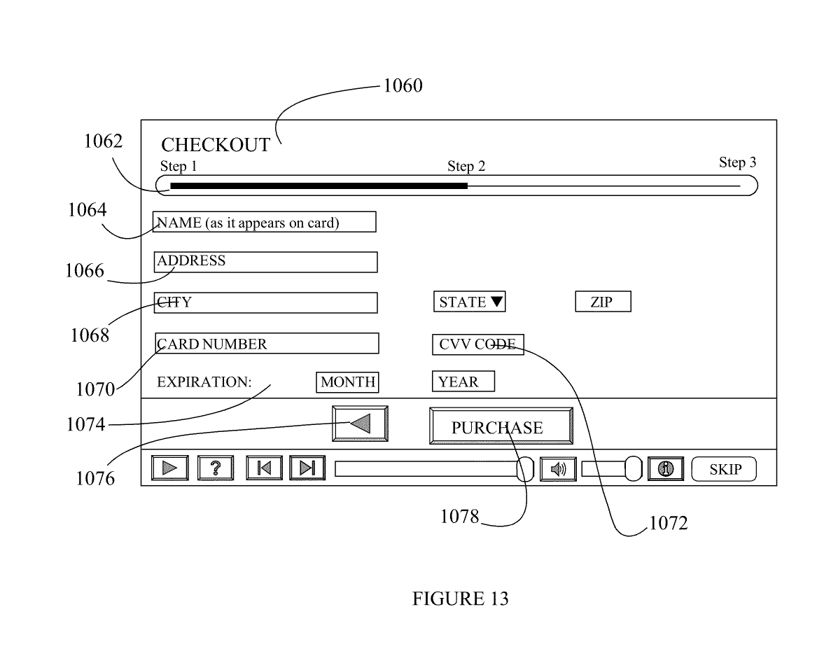

Collect financial information 1120 provides a form, as shown later in FIG. 13, for collection of financial information for the customer if the information is not already provided to the (intermediary) advertiser/seller.

Verify credit card/information 1122 may be instead charging of a debit card, a line of credit, a bank transfer and so on and so forth. In general, this represents transferring money from another organization (a bank, etc.) to the intermediary/advertiser/seller in payment for the product/service.

Send order information to seller 1124 represents the intermediary in turn passing this order to the seller, along with payment received at the same or a later time.

Finally, it is necessary to confirm the order to the buyer as shown at step 1126.

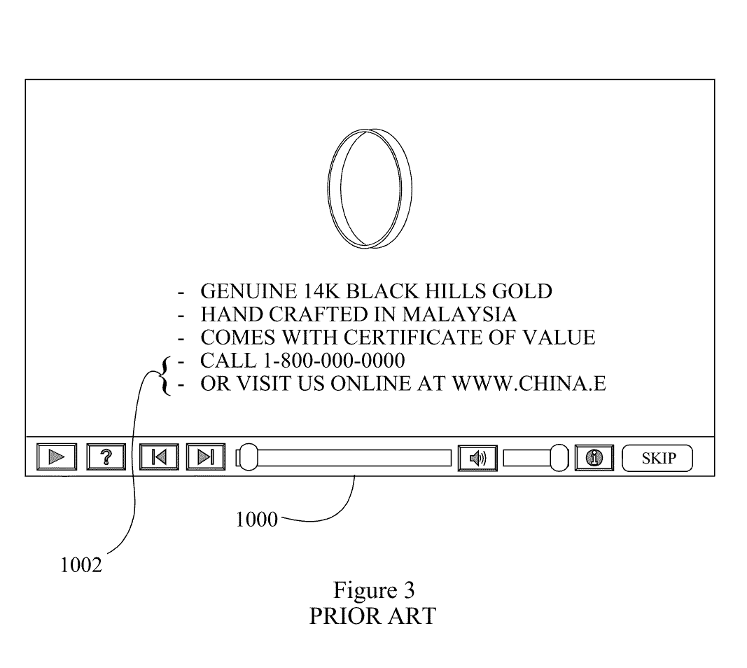

FIG. 3 is a simplified diagram of a PRIOR ART player which is not capable of purchase transactions and is provided for reference only, as discussed previously in the background section of this application.

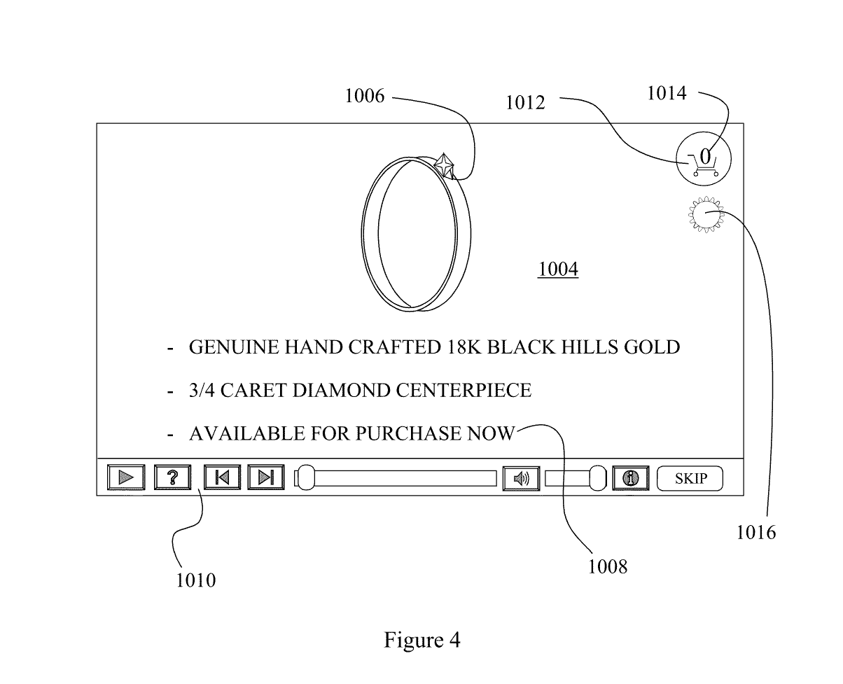

FIG. 4 is a first diagram of a player according to the invention, showing a first product advertised and showing a virtual shopping cart access icon and status indicator.

Purchase capable player 1004 is presently in use by the browsing device and is displaying a media clip, such as a video advertisement which in turn is promoting product 1006.

Video directions to purchase within player 1008 are necessary to remind, or alert, the consumer/customer/buyer that they will have the option to buy the product during the actual advertisement itself. This step may be un-necessary as buyers are expected to very quickly become attuned to the new capability.

Player controls 1010 allow standard player functions such as search, fast forward, volume controls and the like.

Shopping cart access icon 1012 allows the user to display the shopping cart during any time while the player is in use. By clicking on the icon, it functions as a soft button activating the cart and the customer can review their purchases before the end of the advertisement clip.

Shopping cart status icon 1014 displays any of various items concerning the shopping cart. For the present embodiment it displays the number of items in the cart, but it is not so limited.

Shopping cart settings access icon 1016 on the other hand allows a user to access settings concerning their cart. These may include how the cart is used, when it is displayed, how purchases are made, the entry of financial information and its retention or deletion and so on.

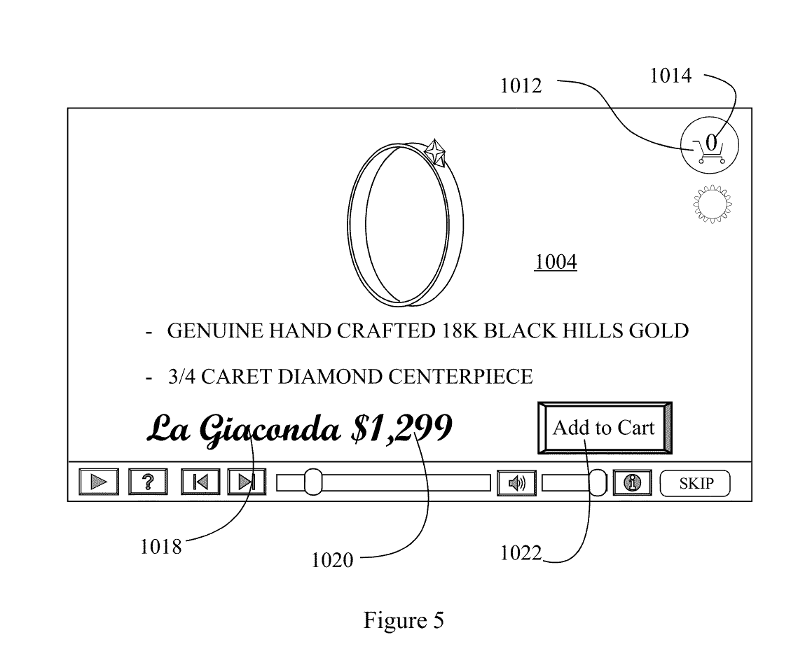

FIG. 5 is a second diagram of a player according to the invention, showing the first product and showing the “Add to Cart” command enabled to the buyer as a button within the player itself. Product name/identification 1018 is provided, as is the cost 1020. Note that in a conventional player this information is optional for an advertisement but in the purchase enabled player, this information, being part of the actual sale of goods, becomes mandatory.

“Add to Cart” button 1022 may now be seen. This button is merely one possible way in which the purchase process may be started, however, soft buttons are familiar to consumers and thus seeing one pop up in an actual piece of content, such as a video advertisement, a movie, a television show or the like should not represent a problem to consumers.

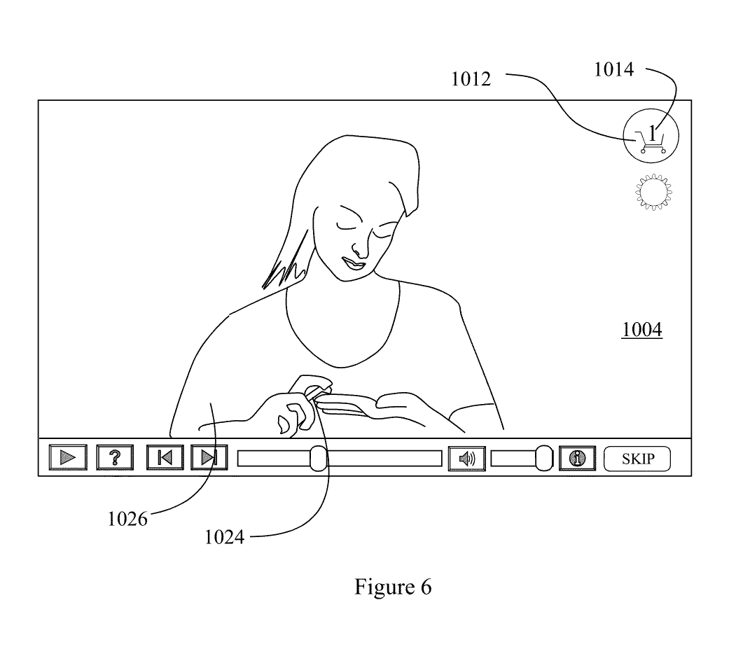

FIG. 6 is a third diagram of a player according to the invention, showing that the virtual shopping cart indicator now registers the presence of an item in the cart, while a second item is now being advertised in the video. Product advertised in video 1024 may be seen with a model or spokesperson who is seen to be carrying out actions such as using the product, demonstrating the product, or perhaps using the product in a movie or during the action of a television show. (1026)

Importantly, the virtual shopping cart status icon has changed, indicating that there is one item already in the cart, presumably, the first product 1006.

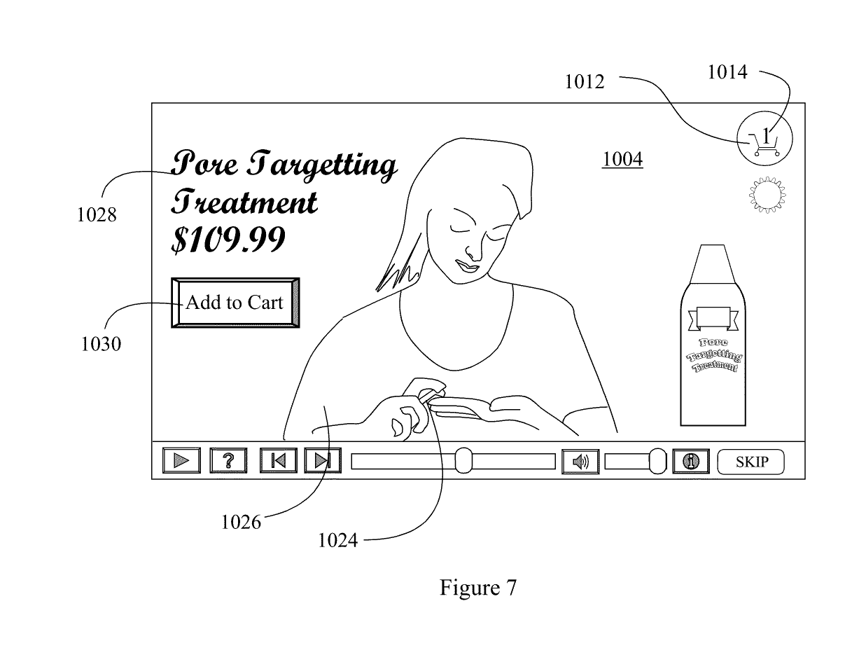

FIG. 7 is a fourth diagram of a player according to the invention, showing the second product with the “Add to Cart” button displayed for the user to purchase the second product if desired. Product name/identification 1028 may be seen for this second product, once again displayed along with the cost and the “Add to Cart” soft button 1030.

While in the diagrams the soft button is shown to be displayed after a period of advertisement of the product, the invention is not so limited: the button may appear at the same time as the product, or when the ad begins, or even before. Partially this is due to the flexibility of the invention, in which the term “within the player” includes the placement of the button, embedded, as a part of the player or as part of the content of the advertisement. In addition, note that the visual placement of the button in either the player or the content does not determine nor is it determined by the code embedding of the button in either the content or the player.

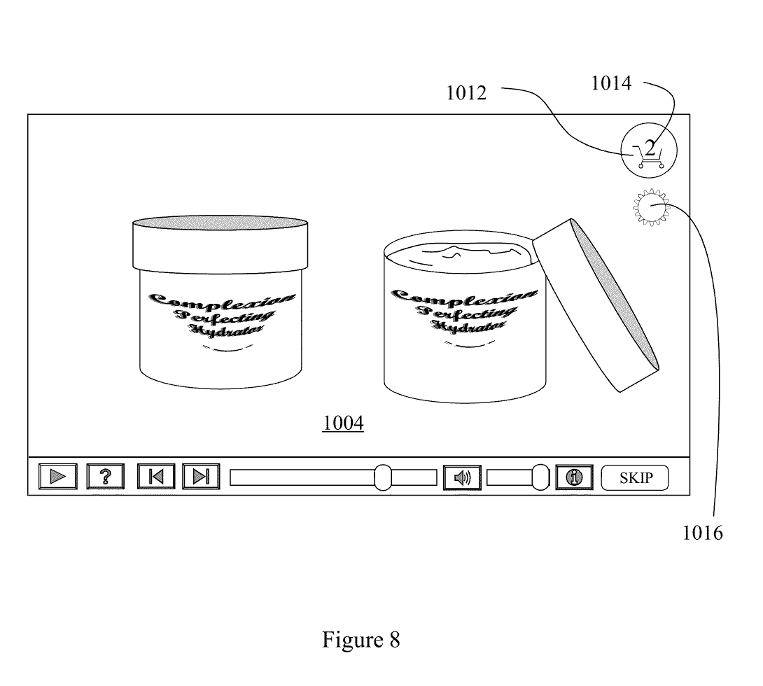

FIG. 8 is a fifth diagram of a player according to the invention, showing yet another product displayed, and showing that the buyer has now placed two items into the virtual shopping cart. These may be the two items previously seen, or may be different as the consumer has the option of choosing which products will go into the cart and which ones will be passed over.

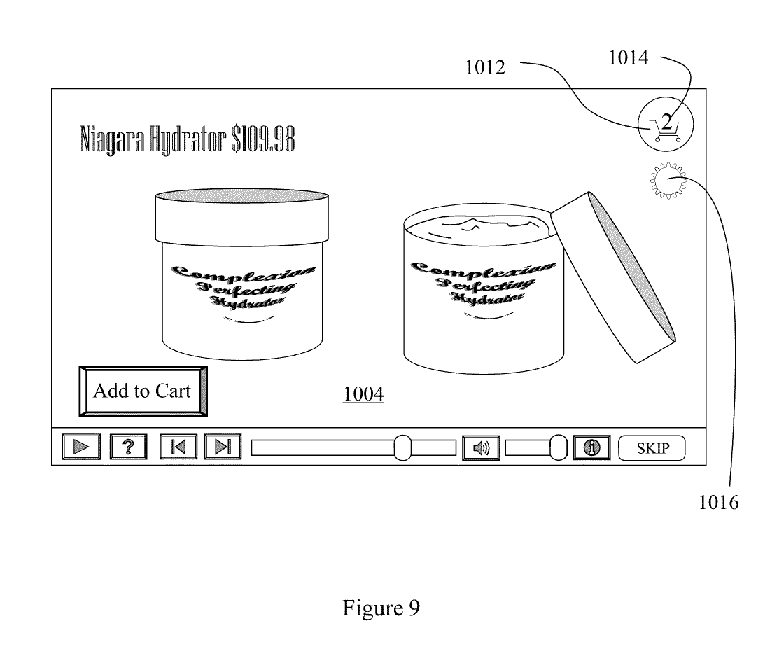

FIG. 9 is a sixth diagram of a player according to the invention, showing the third product is now displayed with the “Add to Cart” button available to the user as shown previously.

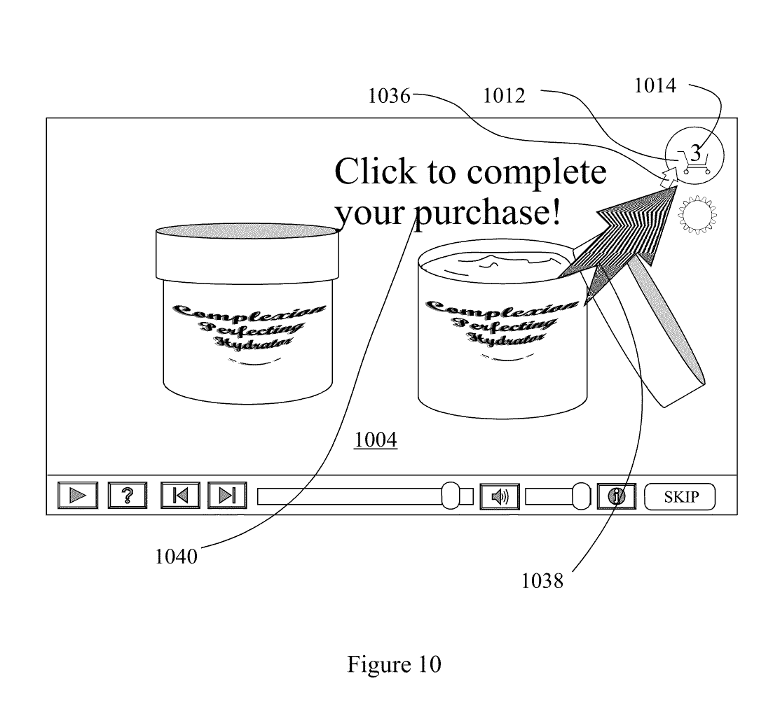

FIG. 10 is a seventh diagram of a player according to the invention, showing indicators to the buyer that the video is coming to an end and that it is time to finalize the purchases, along with a cursor (such as might be used on a non-touch enabled device). Cursor 1036 (the smaller arrow) is perhaps shown in the act of clicking on the virtual shopping cart active icon 1012 for the first time.

Indicia 1038 on the other hand is a larger and eye-catching indicator that the shopping cart has items in it and the time has come, as shown by “End of video/purchase alert” 1040, to make the purchases.

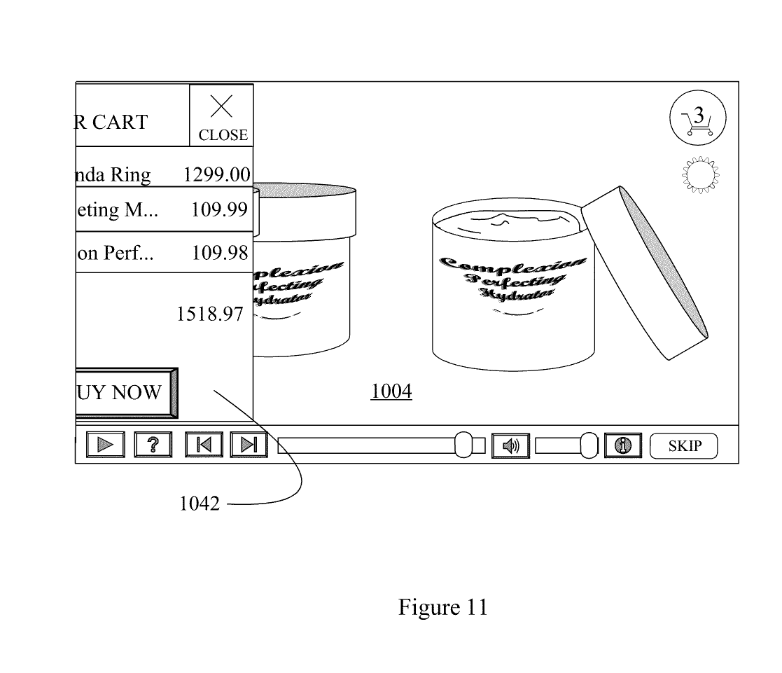

FIG. 11 is a view of a player according to the invention as the virtual shopping cart begins to slide 1042 into the display area for review by the purchaser. Note that while the virtual shopping cart is shown sliding from the side, this is not a requirement of the invention: the cart may appear by many means and can take many visual forms other than that shown.

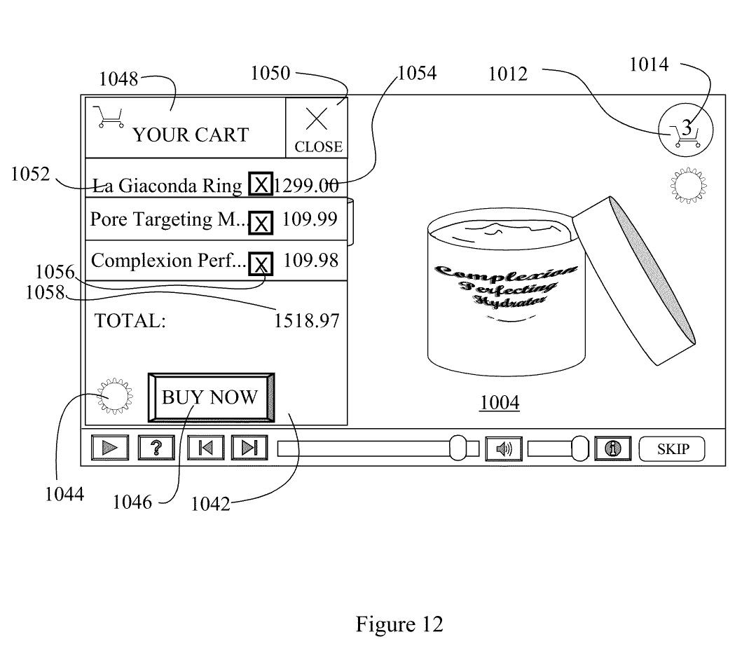

FIG. 12 is a view of a player according to the invention with the virtual shopping cart displayed, showing the numerous details of a virtual shopping cart.

Virtual shopping cart 1042 has an additional or alternative settings icon 1044 in addition to icon 1016, so that users may access the settings while looking at the cart. The settings of the virtual shopping cart may more logically be accessed through the regular player control settings, and thus after consumers become acclimatized to the new shopping system, these icons may obviously be eliminated in embodiments.

Complete purchase button 1046 has the function of moving from review of the shopping cart to the actual transfer of funds to the intermediary or seller.

Virtual shopping cart listing 1048 shows what is in the cart, item by item. While a textual list is displayed for ease of understanding, in fact a pictorial representation of each item is considerably preferable in embodiments.

Close cart button 1050 will allow a consumer who has reviewed their cart to return to media play back, perhaps to review a portion of the advertisement.

Item in cart 1052 is listed by identifying name in this case, but as noted a picture or icon is useful as well, and item cost 1054 is displayed as well.

Delete item from cart button 1056 allows deletion of the item from the cart in the event the buyer changes their mind.

Cost total 1058 is of course necessary. This may in practice include fees, charges, tax, and shipping.

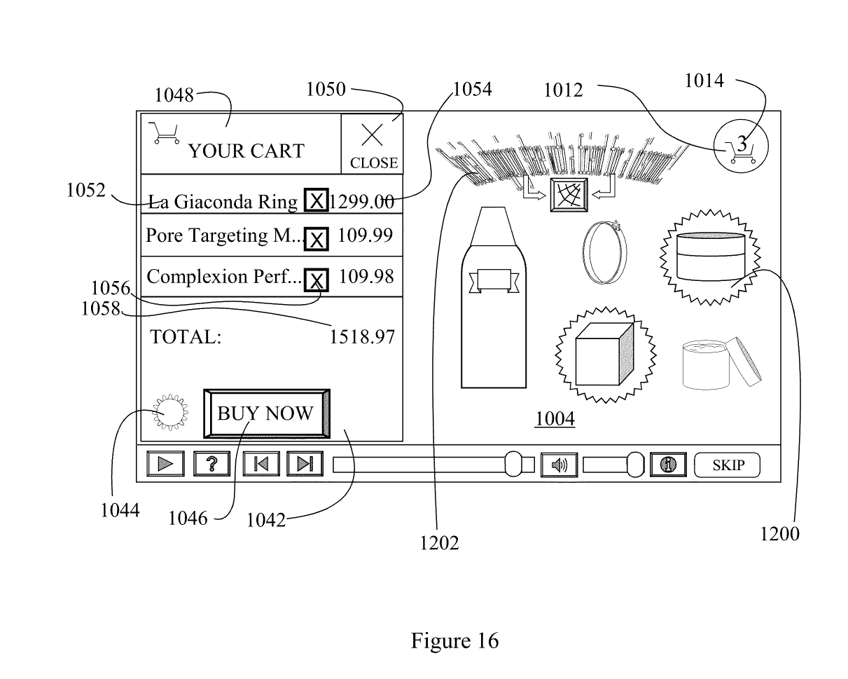

FIG. 16 is a view, equivalent to FIG. 12, of a player in an alternative embodiment of the invention displaying the virtual shopping cart, showing to the user the option to engage in social shopping, and in addition showing all products from the media clip that was played and highlighting products which might not have been selected by the user. All products displayed (1200) shows that at the end of the video, or during the shopping cart display or at any time, the media clip may display all the products advertised in the video. In particular, the products selected may be indicated, or the products not selected may be indicated (as shown in FIG. 16 by star patterns behind the un-selected products). This allows the user to notice if they have missed any product, and to then make use of the purchase capable player to add that product to the virtual shopping cart as well.

Social shopping sharing option 1202 reminds a purchaser that they may share their purchase by social network posting, allowing others to purchase by that means, or may themselves purchase by posting, etc., as described in the patents incorporated herein by reference.

FIG. 13 is a view of a player according to the invention with the checkout module of the purchase-enabled player now displayed for the purchaser to use.

Checkout/point of sale module (1060) includes a status indicator 1062 showing progress of the purchase process. Various fields are provided for entry of the data, including but not limited to the following.

Name for financial data 1064, such as name on credit card, address field one 1066 and additional address fields 1068, for example, city, state, street address, nation and so on. Financial data/credit card number 1070, security code 1072 and other security information such as expiration date 1074, zip codes, bank routing numbers, bank account numbers and so on.

Back button 1076 allows users to return to an earlier phase of the purchase, and finally, purchase button 1078 allows the final actual purchase.

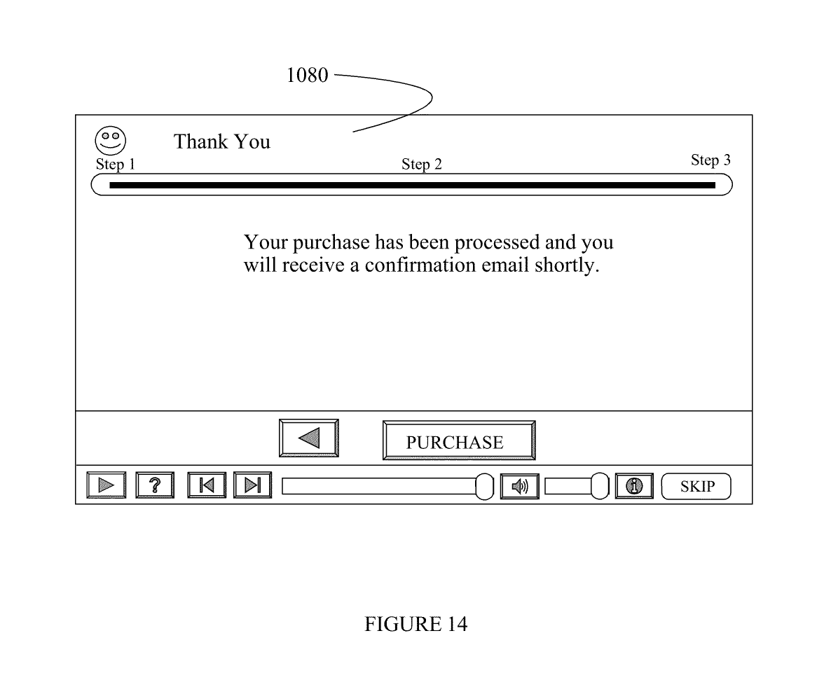

FIG. 14 is a view of a player according to the invention with the order confirmation displayed to the buyer. Confirmation screen 1080 confirms to a buyer that they have completed the transaction.

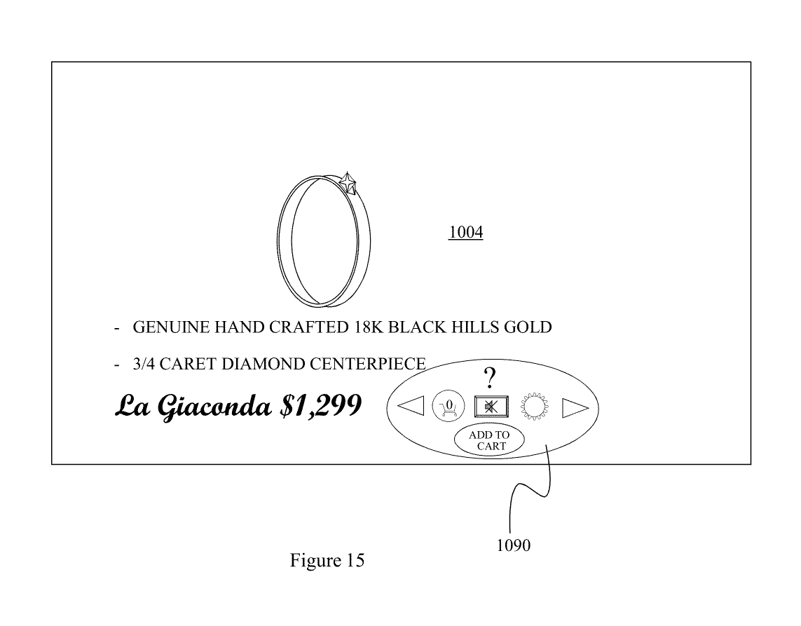

FIG. 15 is a view of a player displaying a product but in this case, the player of the invention has been “skinned”, that is, the player looks and may indeed operate differently, but it is still purchase enabled. The device controls are also shown in a different player skin 1090, illustrating that the device of the invention is not limited to any appearance shown herein nor any standard appearance of a player: most modern media players have skins which allow customization of the appearance.

Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. A method of electronic commerce offered by an electronic advertiser/retailer, for use by a customer having an electronic browsing device and financial information, the method comprising the steps of:
providing a player of online media, the player having the ability to play for such customer a first media clip, the player further having a virtual shopping cart module;
displaying the first media clip for such customer, the player being stored in non-volatile memory of a computer processor;
displaying within the first media clip a first product available for a purchase by such customer;
allowing such customer to be aware that the first product is available for the purchase;
providing to such customer during display of the first media clip an option to purchase the first product;
if such customer opts to purchase the first product, saving the first product in the virtual shopping cart;
displaying the virtual shopping cart within the player;
providing within the player an option to complete the purchase;
if such customer opts to complete the purchase, activating a financial transaction module to complete the purchase;
if such completion of the purchase is successful, placing the purchase order with such electronic advertiser/retailer; and
sending a confirmation to such customer of the successful purchase.

2. The method of electronic commerce of claim 1, wherein the financial transaction module uses such financial information of such customer in the step of completing the purchase, and wherein such financial transaction information is one member selected from the group consisting of: credit card information, bank routing and account number information, loan information and combinations thereof.

3. The method of electronic commerce of claim 2, wherein the step of completing the purchase further comprises:
verifying such financial information by means of one member selected from the group consisting of: verifying a credit card number, security information, and amount, verifying a bank routing number, account number and availability of funds, verifying availability of credit for a loan, and combinations thereof.

4. The method of electronic commerce of claim 3, wherein the financial transaction module further:
determines whether such financial information is stored and associated with such customer;
if such financial information is stored and associated then retrieving such financial information for the step of verification;
if such financial information is not stored and associated then prompting such customer to enter such information while still within the player and transaction module.

5. The method of electronic commerce of claim 5, further comprising:
if such verification step fails, carrying out one step selected from the group consisting of:
prompting such customer to re-enter such financial information, prompting such customer to enter additional financial information, cancelling the purchase, creating a potential fraud alert, and combinations thereof.

6. The method of electronic commerce of claim 1, wherein the browsing device is one member selected from the group consisting of: a computer, a mobile device, a telephone, a tablet computing device, and combinations thereof.

7. The method of electronic commerce of claim 1, wherein the confirmation comprises one member selected from the group consisting of: an email, a text message, an SMS text message, an audio telephone call, a posting on an internet social media, and combinations thereof.

8. The method of electronic commerce of claim 1, wherein the computer processor belongs to such advertiser/retailer and the advertiser/retailer further carries out direct system operations control of the computer processor.

9. The method of electronic commerce of claim 1, for use in an environment with an intermediary media advertiser, wherein:
the computer processor belongs to such intermediary media advertiser and such intermediary media advertiser further carries out direct systems operations control of the computer processor.

10. The method of electronic commerce of claim 1, further comprising:
offering to such customer the option to skip directly to the completion of the purchase from a point within the display of the first media clip prior to completion of the display of the first media clip.

11. The method of electronic commerce of claim 10, further comprising:
displaying to such customer the virtual shopping cart within the player at a point in time selected from the group consisting of: a specific point within the display of the first media clip, an end of display of the first media clip, after such customer accepts such option to skip directly to the completion of the purchase, and combinations thereof.

12. The method of electronic commerce of claim 11, further comprising:
displaying a soft button, wherein clicking on the soft button selects the option to complete the purchase.

13. The method of electronic commerce of claim 12, further comprising:
displaying the soft button within the first media clip.

14. The method of electronic commerce of claim 12, further comprising:
displaying the soft button within the player.

15. The method of electronic commerce of claim 14, further comprising:
displaying within the first media clip an interactive shopping cart icon, capable of causing display of the virtual shopping cart when the icon is activated by such customer.

16. The method of electronic commerce of claim 15, further comprising:
displaying within the first media clip an interactive shopping cart status icon, the interactive shopping cart status icon indicating one member selected from the group consisting of: empty status of the virtual shopping cart, number of items in the virtual shopping cart, presence of stored financial information associated with such customer, total cost of items within the virtual shopping cart, and combinations thereof.

17. The method of electronic commerce of claim 1, wherein the media of the first media clip is one member selected from the group consisting of: metadata, video format data, audio format data, game data, and combinations thereof.

18. The method of electronic commerce of claim 16, further comprising: displaying a second product after displaying the first product, and
displaying all products at a time selected from the group consisting of: when the virtual shopping cart is displayed, at a first end of the media clip, when an all-products icon is activated and combinations thereof.

19. An electronic media player comprising:
a playback module capable of displaying a first media clip;
a purchase module within the player capable of displaying an option to immediately purchase a first product within the first media clip;
a virtual shopping cart module within the player capable of displaying a virtual shopping cart within the first media clip;
a financial transaction module capable of completing a purchase transaction and activated from within the player;
the player being a software module stored upon non-volatile memory in a computer processor.
